(19) United States
(12) Patent Application Publication
(10) Pub. No.: US 2020/0367209 A1
(43) Pub. Date: Nov. 19, 2020

(54) HARQ Offset And Reduced Bi-Field Size In DAI Signaling For Compact DCI In Mobile Communications

(71) Applicant: MediaTek Singapore Pte. Ltd., Singapore (SG)

(72) Inventors: Jozsef Nemeth, Cambridge (GB); Abdellatif Salah, Cambridge (GB); Mohammed S Aleabe Al-Imari, Cambridge (GB); Abdelkader Medles, Cambridge (GB)

(21) Appl. No.: 16/875,962

(22) Filed: May 15, 2020

Related U.S. Application Data
(60) Provisional application No. 62/848,654, filed on May 16, 2019.

(51) Int. Cl. H04W 72/04; H04L 1/18

(52) U.S. Cl. CPC H04W 72/042; H04L 1/1812

(57) ABSTRACT

An apparatus receives, from a wireless network, a message and determines a hybrid automatic repeat request (HARQ) process identification (ID) associated with the message based on a HARQ process number signaled in the message and a HARQ offset. The apparatus also receives, from the wireless network, downlink control information (DCI) from the wireless network containing a counter downlink assignment index (DAI) or a total DAI in a 1-bit field of the DCI.

### CROSS REFERENCE TO RELATED PATENT APPLICATION

The present disclosure is part of a non-provisional patent application claiming the priority benefit of U.S. Provisional Patent Application No. 62/848,654, filed on 16 May 2019, the content of which being incorporated by reference in its entirety.

### TECHNICAL FIELD

The present disclosure is generally related to mobile communications and, more particularly, to hybrid automatic repeat request (HARQ) offset and reduced bit-field size in downlink assignment index (DAI) signaling for compact downlink control information (DCI) in mobile communications.

### BACKGROUND

Unless otherwise indicated herein, approaches described in this section are not prior art to the claims listed below and are not admitted as prior art by inclusion in this section.

In Release 15 (Rel-15) of the 3^{rd} Generation Partnership Project (3GPP) Technical Specification (TS) for New Radio (NR), the HARQ process number bit-field is fixed and has a size of 4 bits both for fallback DCI and for non-fallback DCI. For Ultra-Reliable Low-Latency Communication (URLLC), having a fixed size for the HARQ process number bit-field tends to be unnecessary. Besides, with faster HARQ round-trip time, the number of HARQ processes could be reduced. However, if the size of the HARQ process number bit-field is reduced, a mechanism for a user equipment (UE) to recognize the HARQ process identification (ID) would be needed.

Also, in Rel-15, when DAI counter is signaled to the UE, the size of the DAI field could be 2 or 2+2 bits in multi-carrier cases where the DAI counter is complemented with a DAI count over a totality of the carriers. Each of these counters have 2 bits, and modulo-4 counting may be applied. The configurability could be enhanced to also allow 1-bit DAI counters. This size reduction in the size of DAI counters could be used to further enhance physical downlink control channel (PDCCH) reliability, for example, when the probability to acknowledge more than two DCI's in sub-slots is relatively small or when the probability of burst failures to decode the DCI is kept extremely low. However, a failure detection mechanism would be required.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to HARQ offset and reduced bit-field size in DAI signaling for compact DCI in enhanced URLLC (eURLLC) in mobile communications. Under various proposed schemes in accordance with the present disclosure, a mechanism for a UE to recognize the HARQ process ID and a mechanism for failure detection are introduced.

In one aspect, a method may involve a processor of an apparatus receiving, from a wires network, a message. The method may also involve the processor determining a HARQ process ID associated with the message based on a HARQ process number signaled in the message and a HARQ offset.

In another aspect, a method may involve a processor of an apparatus receiving, from a wires network, DCI containing a counter DAI or a total DAI in a 1-bit field of the DCI. The method may also involve the processor transmitting, to the wireless network, UL DCI containing a DAI in a 1-bit field of the UL DCI.

It is noteworthy that, although description provided herein may be in the context of certain radio access technologies, networks and network topologies such as 5th Generation (5G)/NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ offset and reduced bit-field size in DAI signaling for compact DCI in eURLLC in mobile communications. According to the present disclosure, a number of possible solutions may be implemented separately or jointly. That is, although these possible solutions may be described below separately, two or more of these possible solutions may be implemented in one combination or another.

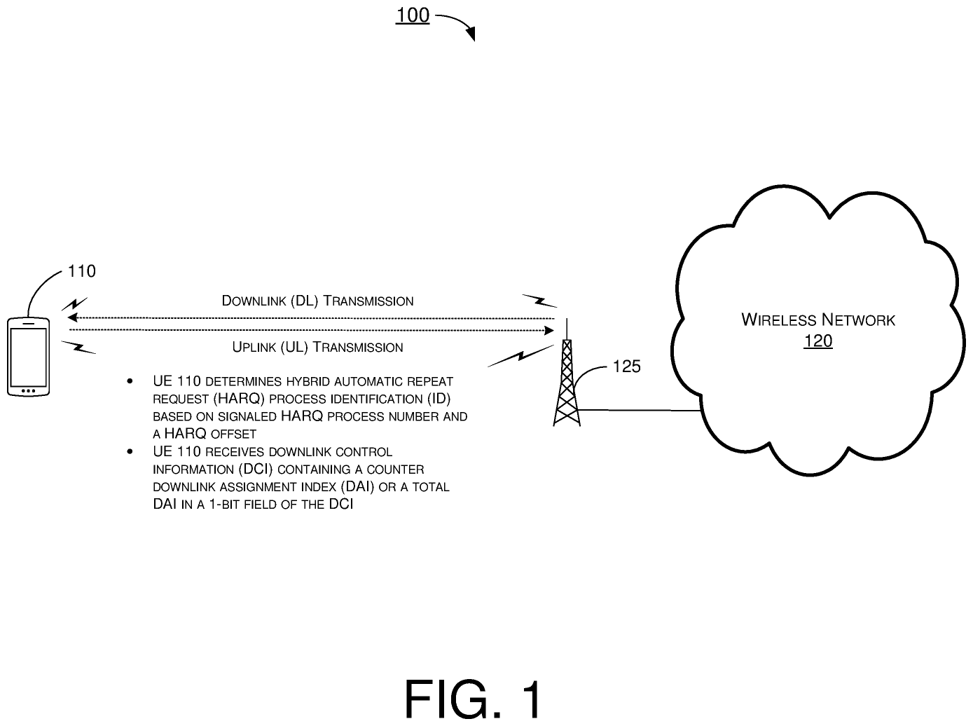

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network). UE 110 may be in wireless communication with wireless network 120 via a base station or network node 125 (e.g., an eNB, gNB or transmit-receive point (TRP)) and perform HARQ offset and reduced bit-field size in DAI signaling for compact DCI in eURLLC in mobile communications based on any of the proposed schemes in accordance with the present disclosure, as described herein.

Under a proposed scheme in accordance with the present disclosure, one option for UE 110 to recognize a HARQ process ID may be to define a HARQ offset for determination of the HARQ process number. The value of the HARQ offset may be radio resource control (RRC)-configured or dynamically signaled by network node 125 to UE 110. For instance, a table of some selected offset values (or possibly all of them) may be specified and UE 110 may be signaled by DCI or higher layers with an index of one of the multiple offset values in the table.

Under a proposed scheme in accordance with the present disclosure, UE 110 may increment the value from the HARQ process number bit-field with the offset so as to obtain the HARQ process ID. For instance, UE 110 may be configured with an offset (HARQ_{offset}) and the HARQ process number (HARQ_{sign}) may be signaled in the bit-field, then the HARQ process ID (HARQ_{ID}) may be determined by: HARQ_{ID}=HARQ_{offset}+HARQ_{sign}.

Under a proposed scheme in accordance with the present disclosure, a wrap-around may be implemented using modulo operation of HARQ acknowledgement (HARQ-ACK) number with respect to the total number of HARQ operations. For instance, HARQ_{ID}=modulo(HARQ_{offset}+HARQ_{sign}, total_number_HARQ_process).

It is noteworthy that mixed enhanced Mobile Broadband (eMBB) and URLLC traffic means that different HARQ processes have different round-trip times (RTTs). The reduced bit-width indexing is used in cased of URLLC having short RTT, and some HARQ process numbers may be taken for eMBB. Moreover, the rules on HARQ process numbering of semi-persistent scheduling (SPS) physical downlink shared channel (PDSCH) may result in some HARQ process numbers being taken. Thus, under various proposed schemes in accordance with the present disclosure, the use of offsets may be necessary. Also, different UEs may need to be configured with different offsets.

In mobile communications, DAI is an index that is communicated by a base station (e.g., network node 125) to a UE (e.g., UE 110) to prevent errors in report acknowledgement and negative acknowledgement (ACK/NACK) due to a HARQ ACK/NACK bundling procedure performed by the UE. Under a proposed scheme in accordance with the present disclosure, the Rel-15 DAI mechanism may be extended with a number of configurable behaviors. For instance, network node 125 may apply a modulo-2 counter for updating a counter DAI. Additionally, the counter DAI may be transmitted as a 1-bit field in the downlink (DL) DCI. Moreover, the total DAI, when transmitted, may be a 1-bit field in the DL DCI. Furthermore, the DAI, when used, may be a 1-bit field in the uplink (UL) DCI. Accordingly, in determination of a HARQ codebook, UE 110 may assume that at least one DCI transmission have been successfully received out of every two DCI transmissions that carry sequential DAI counts. For instance, UE 110 may assume that a wrap-over of the DAI counter has not passed undetected.

### Illustrative Implementations

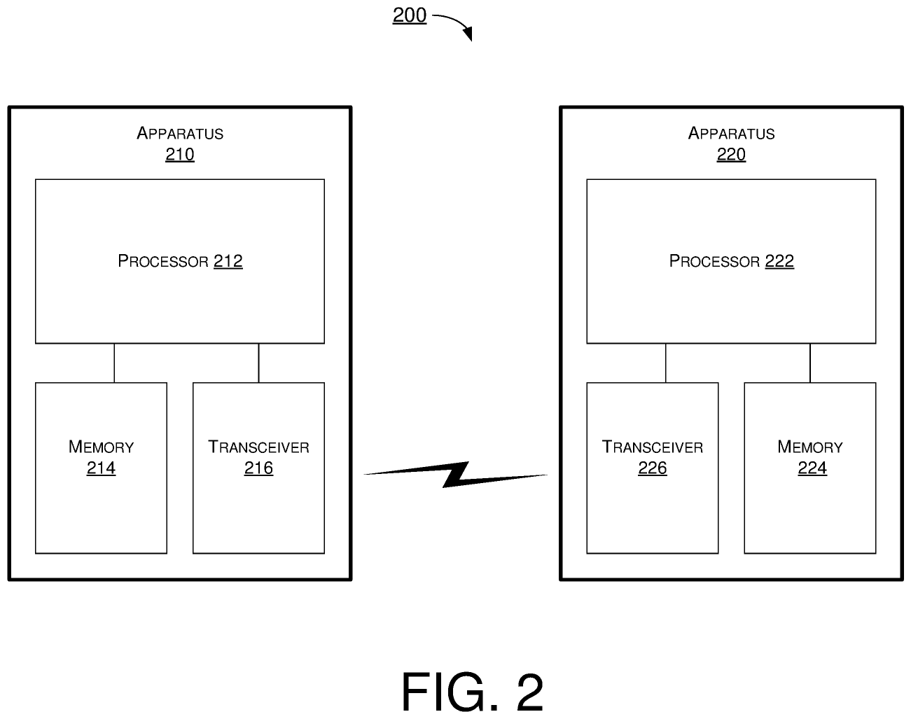

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to HARQ offset and reduced bit-field size in DAI signaling for compact DCI in eURLLC in mobile communications, including the various schemes described above with respect to various proposed designs, concepts, schemes, systems and methods described above as well as processes described below. For instance, apparatus 210 may be an example implementation of UE 110, and apparatus 220 may be an example implementation of network node 125.

Each of apparatus 210 and apparatus 220 may be a part of an electronic apparatus, which may be a network apparatus or a UE (e.g., UE 110), such as a portable or mobile apparatus, a wearable apparatus, a wireless communication apparatus or a computing apparatus. For instance, each of apparatus 210 and apparatus 220 may be implemented in a smartphone, a smart watch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in a network node (e.g., network node 125), such as an eNB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to HARQ offset and reduced bit-field size in DAI signaling for compact DCI in eURLLC in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, apparatus 220 may also include a transceiver 226 coupled to processor 222. Transceiver 226 may include a transceiver capable of wirelessly transmitting and receiving data.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE, and apparatus 220, as a base station of a serving cell of a wireless network (e.g., 5G/NR mobile network), is provided below. It is noteworthy that, although the example implementations described below are provided in the context of a UE, the same may be implemented in and performed by a base station. Thus, although the following description of example implementations pertains to apparatus 210 as a UE (e.g., UE 110), the same is also applicable to apparatus 220 as a network node or base station such as a gNB, TRP or eNodeB (e.g., network node 125) of a wireless network (e.g., wireless network 120) such as a 5G NR mobile network.

Under a proposed scheme in accordance with the present disclosure, processor 212 of apparatus 210 may receive, via transceiver 216, from a wireless network (e.g., wireless network 120) via apparatus 220 as network node 125 a message. Moreover, processor 212 may determine a HARQ process ID associated with the message based on a HARQ process number signaled in the message and a HARQ offset.

In some implementations, in determining the HARQ process ID, processor 212 may determine the HARQ process ID by: HARQ_{ID}=HARQ_{offset}+HARQ_{sign}. Here, HARQ_{ID} may denote the HARQ process ID, HARQ_{offset} may denote the HARQ offset, and HARQ_{sign} may denote the HARQ process number.

In some implementations, in determining the HARQ process ID, processor 212 may determine the HARQ process ID by: HARQ_{ID}=modulo(HARQ_{offset}+HARQ_{sign}, total_number_HARQ_process). Here, HARQ_{ID} may denote the HARQ process ID, HARQ_{offset} may denote the HARQ offset, HARQ_{sign} may denote the HARQ process number, and total_number_HARQ_process may denote a total number of HARQ operations.

In some implementations, the HARQ process ID may be indicated in a HARQ process number bit-field having a size that is configurable and not fixed.

In some implementations, processor 212 may perform additional operations. For instance, processor 212 may receive, via transceiver 216, from the wireless network via apparatus 220 a RRC signaling that configures a value of the HARQ offset. Alternatively, processor 212 may receive, via transceiver 216, from the wireless network via apparatus 220 a dynamic signaling that configures a value of the HARQ offset.

In some implementations, processor 212 may receive, via transceiver 216, from the wireless network via apparatus 220 an indication of an index to one of a plurality of offsets in a table (which may be stored in memory 214 of apparatus 200). In such cases, the one of the plurality of offsets indicated by the index may correspond to the HARQ offset. Moreover, in receiving the indication, processor 212 may receive DCI containing the indication.

In some implementations, processor 212 may also receive, via transceiver 216, DL DCI from the wireless network via apparatus 220 containing a counter DAI or a total DAI in a 1-bit field of the DCI.

In some implementations, processor 212 may also transmit, via transceiver 216, UL DCI to the wireless network containing a DAI in a 1-bit field of the UL DCI.

In some implementations, processor 212 may also determine a HARQ codebook based on an assumption that at least one DCI transmission has been successfully received out of every two DCI transmissions that carry sequential DAI counts.

Under another proposed scheme in accordance with the present disclosure, processor 212 of apparatus 210 may receive, via transceiver 216, from a wireless network (e.g., wireless network 120) via apparatus 220 as network node 125 DCI containing a counter DAI or a total DAI in a 1-bit field of the DCI. Additionally, processor 212 may transmit, via transceiver 216, UL DCI to the wireless network containing a DAI in a 1-bit field of the UL DCI.

In some implementations, processor 212 may determine a HARQ codebook based on an assumption that at least one DCI transmission has been successfully received out of every two DCI transmissions that carry sequential DAI counts.

In some implementations, processor 212 may perform additional operations. For instance, processor 212 may receive, via transceiver 216, a message from the wireless network. Additionally, processor 212 may determine a HARQ process ID associated with the message based on a HARQ process number signaled in the message and a HARQ offset.

In some implementations, in determining the HARQ process ID, processor 212 may determine the HARQ process ID by: HARQ_{ID}=HARQ_{offset}+HARQ_{sign}. Here, HARQ_{ID} may denote the HARQ process ID, HARQ_{offset} may denote the HARQ offset, and HARQ_{sign} may denote the HARQ process number.

In some implementations, in determining the HARQ process ID, processor 212 may determine the HARQ process ID by: HARQ_{ID}=modulo(HARQ_{offset}+HARQ_{sign}, total_number_HARQ_process). Here, HARQ_{ID} may denote the HARQ process ID, HARQ_{offset} may denote the HARQ offset, HARQ_{sign} may denote the HARQ process number, and total_number_HARQ_process may denote a total number of HARQ operations.

In some implementations, the HARQ process ID may be indicated in a HARQ process number bit-field having a size that is configurable and not fixed.

In some implementations, processor 212 may perform additional operations. For instance, processor 212 may receive, via transceiver 216, from the wireless network via apparatus 220 a RRC signaling that configures a value of the HARQ offset. Alternatively, processor 212 may receive, via transceiver 216, from the wireless network via apparatus 220 a dynamic signaling that configures a value of the HARQ offset.

In some implementations, processor 212 may also receive, via transceiver 216, from the wireless network via apparatus 220 an indication of an index to one of a plurality of offsets in a table (which may be stored in memory 214 of apparatus 200). In such cases, the one of the plurality of offsets indicated by the index may correspond to the HARQ offset. Moreover, in receiving the indication, processor 212 may receive DCI containing the indication.

### Illustrative Processes

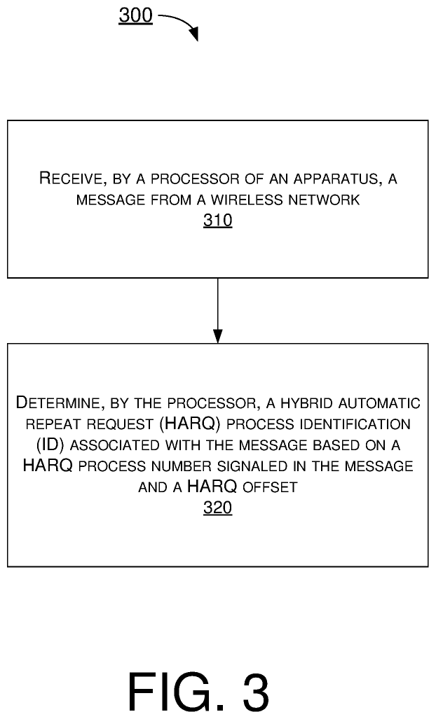

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to HARQ offset and reduced bit-field size in DAI signaling for compact DCI in eURLLC in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a network node (e.g., network node 125) of a wireless network (e.g., wireless network 120) such as a 5G/NR mobile network. Process 300 may begin at block 310.

At 310, process 300 may involve processor 212 of apparatus 210 receiving, via transceiver 216, from a wireless network (e.g., wireless network 120) via apparatus 220 as network node 125 a message. Process 300 may proceed from 310 to 320.

At 320, process 300 may involve processor 212 determining a HARQ process ID associated with the message based on a HARQ process number signaled in the message and a HARQ offset.

In some implementations, in determining the HARQ process ID, process 300 may involve processor 212 determining the HARQ process ID by: HARQ_{ID}=HARQ_{offset}+HARQ_{sign}. Here, HARQ_{ID} may denote the HARQ process ID, HARQ_{offset} may denote the HARQ offset, and HARQ_{sign} may denote the HARQ process number.

In some implementations, in determining the HARQ process ID, process 300 may involve processor 212 determining the HARQ process ID by: HARQ_{ID}=modulo(HARQ_{offset}+HARQ_{sign}, total_number_HARQ_process). Here, HARQ_{ID} may denote the HARQ process ID, HARQ_{offset} may denote the HARQ offset, HARQ_{sign} may denote the HARQ process number, and total_number_HARQ_process may denote a total number of HARQ operations.

In some implementations, the HARQ process ID may be indicated in a HARQ process number bit-field having a size that is configurable and not fixed.

In some implementations, process 300 may involve processor 212 performing additional operations. For instance, process 300 may involve processor 212 receiving, via transceiver 216, from the wireless network via apparatus 220 a RRC signaling that configures a value of the HARQ offset. Alternatively, process 300 may involve processor 212 receiving, via transceiver 216, from the wireless network via apparatus 220 a dynamic signaling that configures a value of the HARQ offset.

In some implementations, process 300 may also involve processor 212 receiving, via transceiver 216, from the wireless network via apparatus 220 an indication of an index to one of a plurality of offsets in a table (which may be stored in memory 214 of apparatus 200). In such cases, the one of the plurality of offsets indicated by the index may correspond to the HARQ offset. Moreover, in receiving the indication, process 300 may involve processor 212 receiving DCI containing the indication.

In some implementations, process 300 may also involve processor 212 receiving, via transceiver 216, DL DCI from the wireless network via apparatus 220 containing a counter DAI or a total DAI in a 1-bit field of the DCI.

In some implementations, process 300 may also involve processor 212 transmitting, via transceiver 216, UL DCI to the wireless network containing a DAI in a 1-bit field of the UL DCI.

In some implementations, process 300 may also involve processor 212 determining a HARQ codebook based on an assumption that at least one DCI transmission has been successfully received out of every two DCI transmissions that carry sequential DAI counts.

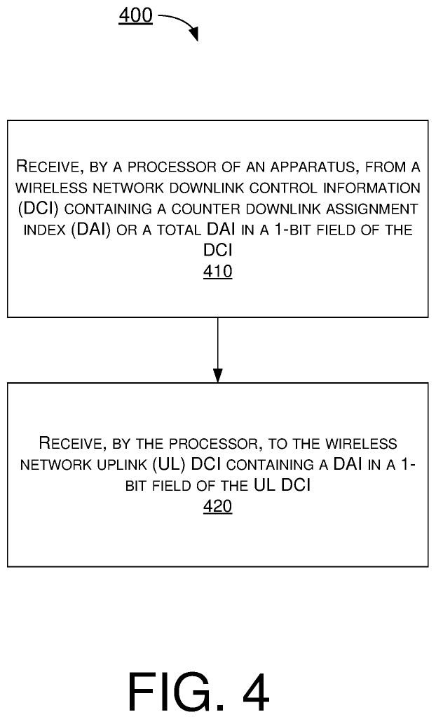

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to HARQ offset and reduced bit-field size in DAI signaling for compact DCI in eURLLC in mobile communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a network node (e.g., network node 125) of a wireless network (e.g., wireless network 120) such as a 5G/NR mobile network. Process 400 may begin at block 410.

At 410, process 400 may involve processor 212 of apparatus 210 receiving, via transceiver 216, DCI from a wireless network (e.g., wireless network 120) via apparatus 220 as network node 125 with the DCI containing a counter DAI or a total DAI in a 1-bit field of the DCI. Process 400 may proceed from 410 to 420.

At 420, process 400 may involve processor 212 transmitting, via transceiver 216, UL DCI to the wireless network containing a DAI in a 1-bit field of the UL DCI.

In some implementations, process 400 may also involve processor 212 determining a HARQ codebook based on an assumption that at least one DCI transmission has been successfully received out of every two DCI transmissions that carry sequential DAI counts.

In some implementations, process 300 may involve processor 212 performing additional operations. For instance, process 300 may involve processor 212 receiving, via transceiver 216, a message from the wireless network. Additionally, process 300 may involve processor 212 determining a HARQ process ID associated with the message based on a HARQ process number signaled in the message and a HARQ offset.

In some implementations, in determining the HARQ process ID, process 300 may involve processor 212 determining the HARQ process ID by: HARQ_{ID}=HARQ_{offset}+HARQ_{sign}. Here, HARQ_{ID} may denote the HARQ process ID, HARQ_{offset} may denote the HARQ offset, and HARQ_{sign} may denote the HARQ process number.

In some implementations, in determining the HARQ process ID, process 300 may involve processor 212 determining the HARQ process ID by: HARQ_{ID}=modulo(HARQ_{offset}+HARQ_{sign}, total_number_HARQ_process). Here, HARQ_{ID} may denote the HARQ process ID, HARQ offset may denote the HARQ offset, HARQ_{sign} may denote the HARQ process number, and total_number_HARQ_process may denote a total number of HARQ operations.

In some implementations, the HARQ process ID may be indicated in a HARQ process number bit-field having a size that is configurable and not fixed.

In some implementations, process 400 may involve processor 212 performing additional operations. For instance, process 400 may involve processor 212 receiving, via transceiver 216, from the wireless network via apparatus 220 a RRC signaling that configures a value of the HARQ offset. Alternatively, process 400 may involve processor 212 receiving, via transceiver 216, from the wireless network via apparatus 220 a dynamic signaling that configures a value of the HARQ offset.

In some implementations, process 400 may also involve processor 212 receiving, via transceiver 216, from the wireless network via apparatus 220 an indication of an index to one of a plurality of offsets in a table (which may be stored in memory 214 of apparatus 200). In such cases, the one of the plurality of offsets indicated by the index may correspond to the HARQ offset. Moreover, in receiving the indication, process 400 may involve processor 212 receiving DCI containing the indication.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a message from a wireless network; and
determining, by the processor, a hybrid automatic repeat request (HARQ) process identification (ID) associated with the message based on a HARQ process number signaled in the message and a HARQ offset.

2. The method of claim 1, wherein the determining of the HARQ process ID comprises determining the HARQ process ID by:
HARQ_{ID}=HARQ_{offset}+HARQ_{sign},
wherein HARQ_{ID} denotes the HARQ process ID,
wherein HARQ_{offset} denotes the HARQ offset, and
wherein HARQ_{sign} denotes the HARQ process number.

3. The method of claim 1, wherein the determining of the HARQ process ID comprises determining the HARQ process ID by:
HARQ_{ID}=modulo(HARQ_{offset}+HARQ_{sign},total_number_HARQ_process),
wherein HARQ_{ID} denotes the HARQ process ID,
wherein HARQ_{offset} denotes the HARQ offset,
wherein HARQ_{sign} denotes the HARQ process number, and
wherein total_number_HARQ_process denotes a total number of HARQ operations.

4. The method of claim 1, wherein the HARQ process ID is indicated in a HARQ process number bit-field having a size that is configurable and not fixed.

5. The method of claim 1, further comprising:
receiving, by the processor, from the wireless network a radio resource control (RRC) signaling that configures a value of the HARQ offset.

6. The method of claim 1, further comprising:
receiving, by the processor, from the wireless network a dynamic signaling that configures a value of the HARQ offset.

7. The method of claim 1, further comprising:
receiving, by the processor, from the wireless network an indication of an index to one of a plurality of offsets in a table,
wherein the one of the plurality of offsets indicated by the index corresponds to the HARQ offset.

8. The method of claim 7, wherein the receiving of the indication comprises receiving downlink control information (DCI) containing the indication.

9. The method of claim 1, further comprising:
receiving, by the processor, downlink control information (DCI) from the wireless network containing a counter downlink assignment index (DAI) or a total DAI in a 1-bit field of the DCI.

10. The method of claim 1, further comprising:
transmitting, by the processor, uplink (UL) downlink control information (DCI) to the wireless network containing a downlink assignment index (DAI) in a 1-bit field of the UL DCI.

11. The method of claim 1, further comprising:
determining, by the processor, a HARQ codebook based on an assumption that at least one downlink control information (DCI) transmission has been successfully received out of every two DCI transmissions that carry sequential downlink assignment index (DAI) counts.

12. A method, comprising:
receiving, by a processor of an apparatus, from a wireless network downlink control information (DCI) containing a counter downlink assignment index (DAI) or a total DAI in a 1-bit field of the DCI; and
transmitting, by the processor, to the wireless network uplink (UL) DCI containing a DAI in a 1-bit field of the UL DCI.

13. The method of claim 12, further comprising:
determining, by the processor, a hybrid automatic repeat request (HARQ) codebook based on an assumption that at least one DCI transmission has been successfully received out of every two DCI transmissions that carry sequential DAI counts.

14. The method of claim 12, further comprising:
receiving, by the processor, a message from the wireless network; and
determining, by the processor, a hybrid automatic repeat request (HARQ) process identification (ID) associated with the message based on a HARQ process number signaled in the message and a HARQ offset.

15. The method of claim 14, wherein the determining of the HARQ process ID comprises determining the HARQ process ID by:
HARQ_{ID}=HARQ_{offset}+HARQ_{sign},
wherein HARQ_{ID} denotes the HARQ process ID,
wherein HARQ_{offset} denotes the HARQ offset, and
wherein HARQ_{sign} denotes the HARQ process number.

16. The method of claim 14, wherein the determining of the HARQ process ID comprises determining the HARQ process ID by:
HARQ_{ID}=modulo(HARQ_{offset}+HARQ_{sign},total_number_HARQ_process),
wherein HARQ_{ID} denotes the HARQ process ID,
wherein HARQ_{offset} denotes the HARQ offset,
wherein HARQ_{sign} denotes the HARQ process number, and
wherein total_number_HARQ_process denotes a total number of HARQ operations.

17. The method of claim 14, wherein the HARQ process ID is indicated in a HARQ process number bit-field having a size that is configurable and not fixed.

18. The method of claim 14, further comprising:
receiving, by the processor, from the wireless network a radio resource control (RRC) signaling that configures a value of the HARQ offset.

19. The method of claim 14, further comprising:
receiving, by the processor, from the wireless network a dynamic signaling that configures a value of the HARQ offset.

20. The method of claim 14, further comprising:
receiving, by the processor, from the wireless network an indication of an index to one of a plurality of offsets in a table,
wherein the one of the plurality of offsets indicated by the index corresponds to the HARQ offset.
